(19) United States
(12) Patent Application Publication
(10) Pub. No.: US 2026/0067507 A1
(43) Pub. Date: Mar. 5, 2026

(54) CROSS-COMPONENT SAMPLE OFFSET (CCSO)

(71) Applicant: Tencent America LLC, Palo Alto, CA (US)

(72) Inventors: Tianqi LIU, Palo Alto, CA (US); Liang ZHAO, Palo Alto, CA (US); Madhu PERINGASSERY KRISHNAN, Palo Alto, CA (US); Shan LIU, Palo Alto, CA (US)

(21) Appl. No.: 19/207,248

(22) Filed: May 13, 2025

Related U.S. Application Data
(60) Provisional application No. 63/688,283, filed on Aug. 28, 2024.

(51) Int. Cl. H04N 19/82; H04N 19/117; H04N 19/186; H04N 19/70

(52) U.S. Cl. CPC H04N 19/82; H04N 19/117; H04N 19/186; H04N 19/70

(57) ABSTRACT

Various implementations described herein include methods and systems for coding video. In one aspect, a video bitstream includes a current image frame and a first syntax element for a CCSO mode. When the CCSO mode is enabled, a plurality of candidate luma sets are identified in a filter range that includes a first luma sample and neighboring luma samples. Each candidate luma set includes respective luma samples having positions symmetric with respect to a position of the first luma sample, and each luma sample located in the filter range is used in at least one of the candidate luma sets. A set of target luma samples is selected from the candidate luma sets. A loop filter is applied to combine the set of target luma samples and the first luma sample to generate the first sample offset of a first color sample collocated with the first luma sample.

### RELATED APPLICATIONS

This application claims priority to U.S. Provisional Ser. No. 63/688,283, entitled “CCSO Improvements,” filed Aug. 28, 2024, which is hereby incorporated by reference in its entirety.

### TECHNICAL FIELD

The disclosed embodiments relate generally to video coding, including but not limited to systems and methods for loop filtering (e.g., cross-component offset filtering) of video data.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016(version 4). Versatile Video Coding (VVC/H.266) is a video compression standard intended as a successor to HEVC. ITU-T and ISO/IEC published the VVC/H.266 standard in 2020(version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

As mentioned above, encoding (compression) reduces the bandwidth and/or storage space requirements. As described in detail later, both lossless compression and lossy compression can be employed. Lossless compression refers to techniques where an exact copy of the original signal can be reconstructed from the compressed original signal via a decoding process. Lossy compression refers to coding/decoding process where original video information is not fully retained during coding and not fully recoverable during decoding. When using lossy compression, the reconstructed signal may not be identical to the original signal, but the distortion between original and reconstructed signals is made small enough to render the reconstructed signal useful for the intended application. The amount of tolerable distortion depends on the application. For example, users of certain consumer video streaming applications may tolerate higher distortion than users of cinematic or television broadcasting applications. The compression ratio achievable by a particular coding algorithm can be selected or adjusted to reflect various distortion tolerance: higher tolerable distortion generally allows for coding algorithms that yield higher losses and higher compression ratios.

The present disclosure describes methods, systems, and non-transitory computer-readable storage media for applying a loop filter for video (image) compression. A video codec includes a plurality of function modules for one or more of: intra/inter prediction, transform coding, quantization, entropy coding, and in-loop filtering. In-loop filtering technologies are applied to adjust reconstructed picture samples to further reduce a reconstruction error. A cross-component offset filtering method is implemented to apply a co-located reconstructed sample and associated neighboring reconstructed samples of a first color component to derive an offset value that is added on a current sample of a second color component, thereby adjusting a reconstruction value of the current sample. Examples of the first color component is a luma color component, and examples of the second color component is a chroma color component. In some implementations, the first color component and the second color component correspond to the same color component, e.g., luma sample.

In various embodiments of this application, samples of a first color component are processed by a cross-component offset filter in loop filtering to determine an offset value that is added on a sample of a second color component. Cross-component offset filtering is implemented based on a loop filter that using reconstructed color samples to determine the sample offsets of luma and/or chroma components. For example, a sample offset is determined based on luma values of a first luma sample and one or more neighboring luma samples. In some embodiments, the sample offset is determined based on edge offsetting corresponding to gradients between the first luma sample and associated neighboring luma sample(s). Alternatively, in some embodiments, the sample offset is determined based on band offsetting corresponding to the luma values (not the gradients) of the first luma sample and associated neighboring luma sample(s). Additionally, in some embodiments, filter shapes for cross component sample offset classification are configured to reduce the worst-case memory access.

In accordance with some embodiments, a method of video decoding is provided. The method includes receiving a video bitstream including a current image frame and a first syntax element for a cross-component sample offset (CCSO) mode indicating whether to generate a first sample offset of a first color sample of the current image frame based on one or more luma samples. The method further includes, when the first syntax element indicates that CCSO mode is enabled, identifying a plurality of candidate luma sets in a filter range. The filter range includes a first luma sample collocated with the first color sample and a plurality of neighboring luma samples of the first luma sample, and each candidate luma set includes a plurality of respective luma samples having positions that are symmetric with respect to a first position of the first luma sample. Each luma sample located in the filter range is used in at least one of the plurality of candidate luma sets. The method further includes selecting a set of target luma samples from the plurality of candidate luma sets and applying a loop filter to combine the set of target luma samples and the first luma sample to generate the first sample offset of the first color sample. The method further includes reconstructing the current image frame at least by adjusting the first color sample based on the first sample offset.

In accordance with some embodiments, a method of video encoding is provided. The method includes receiving video data comprising a current image frame, encoding the current image frame, transmitting the encoded current image frame via a video bitstream, and signaling, via the video bitstream, a first syntax element for a cross-component sample offset (CCSO) mode indicating whether to generate a first sample offset of a first color sample of the current image frame based on one or more luma samples. When the CCSO mode is enabled, a set of target luma samples is selected from a plurality of candidate luma sets in a filter range, and combined with a first luma sample, which is collocated with the first color sample, according to a loop filter to generate the first sample offset of the first color sample. The filter range includes the first luma sample and a plurality of neighboring luma samples of the first luma sample, and each candidate luma set includes a plurality of respective luma samples having positions that are symmetric with respect to a first position of the first luma sample. Each luma sample located in the filter range is used in at least one of the plurality of candidate luma sets.

In accordance with some embodiments, a method of bitstream conversion is provided. The method includes obtaining a source video sequence including a current image frame and performing a conversion between the source video sequence and a video bitstream. The video bitstream includes the current image frame and a first syntax element for a cross-component sample offset (CCSO) mode indicating whether to generate a first sample offset of a first color sample of the current image frame based on one or more luma samples. When the CCSO mode is enabled, a set of target luma samples is selected from a plurality of candidate luma sets in a filter range, and combined with a first luma sample, which is collocated with the first color sample, according to a loop filter to generate the first sample offset of the first color sample. The filter range includes the first luma sample and a plurality of neighboring luma samples of the first luma sample, and each candidate luma set includes a plurality of respective luma samples having positions that are symmetric with respect to a first position of the first luma sample. Each luma sample located in the filter range is used in at least one of the plurality of candidate luma sets.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and/or a decoder component.

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for coding video. Such methods, devices, and systems may complement or replace conventional methods, devices, and systems for video coding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments, and

FIG. 2B is a block diagram illustrating example elements of a decoder component in accordance with some embodiments.

FIG. 3 is a block diagram illustrating an example server system in accordance with some embodiments.

FIG. 4 is a flow diagram of an example process of applying loop filtering in a CCSO mode based on a filter shape, in accordance with some embodiments.

FIGS. 5A and 5B illustrate two example filter ranges where a plurality of candidate luma sets are identified, in accordance with some embodiments.

FIGS. 6A and 6B illustrate a plurality of example candidate luma sets identified in a filter range, in accordance with some embodiments.

FIGS. 7A and 7B illustrate a plurality of example candidate luma sets identified in another filter range having a rectangular shape, in accordance with some embodiments.

FIGS. 8A and 8B illustrate a plurality of example candidate luma sets identified in a filter range having a diamond shape, in accordance with some embodiments.

FIGS. 9A-9D are four example filter shapes of combining more than two neighboring luma samples in a CCSO mode, in accordance with some embodiments.

FIG. 10 is a flow diagram illustrating a method of coding video, in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes methods, systems, and non-transitory computer-readable storage media for applying a loop filter for video (image) compression. In-loop filtering technologies are applied to adjust reconstructed picture samples to further reduce a reconstruction error. A cross-component offset filtering method is implemented to apply a collocated reconstructed sample and associated neighboring reconstructed samples of a first color component to derive an offset value that is added on a current sample of a second color component, thereby adjusting a reconstruction value of the current sample. In various embodiments of this application, a decoder receives a video bitstream from an encoder including a current image frame and a first syntax element indicating whether a first sample offset of a first color sample is determined based on values of one or more luma samples. Sample values of a first color component are used in cross-component offset filtering to determine an offset value that is added on a sample of a second color component. For example, luma samples are applied to generate an offset value of a first luma sample or a first chroma sample that is collocated with the first luma sample.

More specifically, in some embodiments, when the first syntax element indicates that the CCSO mode is enabled, a video decoder identifies a plurality of candidate luma sets in a filter range. The filter range includes a first luma sample collocated with the first color sample and a plurality of neighboring luma samples of the first luma sample, and each candidate luma set includes a plurality of respective luma samples having positions that are symmetric with respect to a first position of the first luma sample. Each luma sample located in the filter range is used in at least one of the plurality of candidate luma sets. The video decoder selects a set of target luma samples from the plurality of candidate luma sets, and applies a loop filter to combine the set of target luma samples to generate the first sample offset of the first color sample. The video decoder reconstructs the current image frame at least by adjusting the first color sample based on the first sample offset.

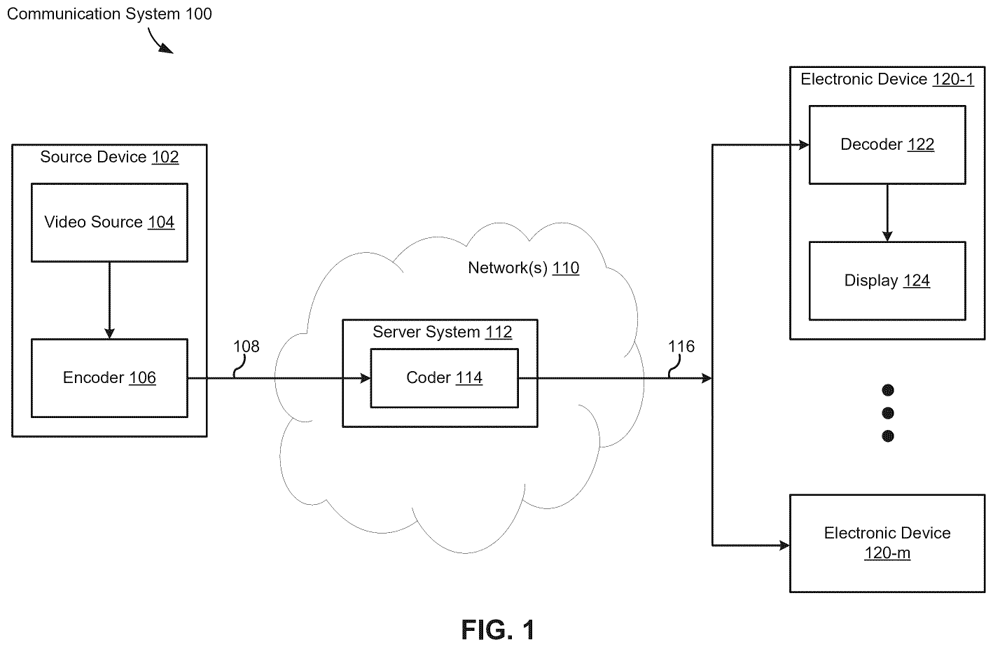

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

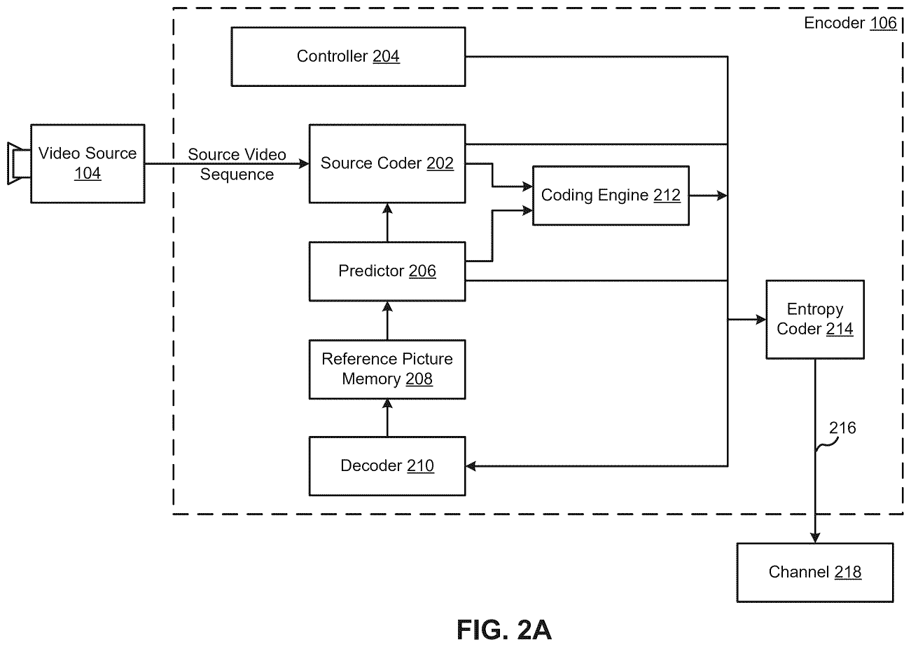

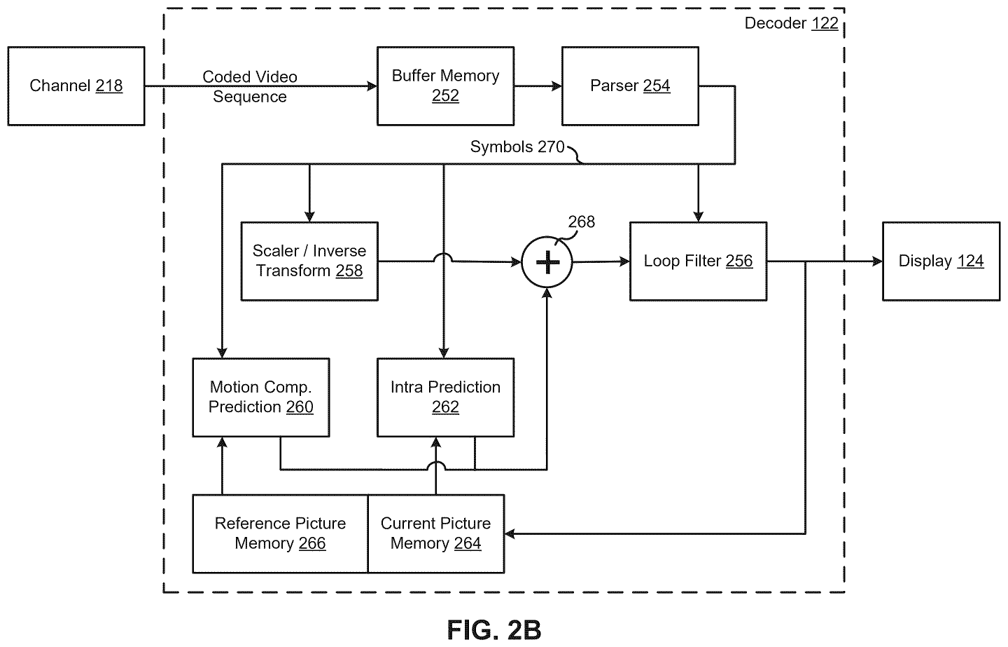

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding. This principle of reference picture synchronicity (and resulting drift, if synchronicity cannot be maintained, for example because of channel errors) is known to a person of ordinary skill in the art.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. The description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks'respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, for example, temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation also can include interpolation of sample values as fetched from the reference picture memory 266 when sub-sample exact motion vectors are in use, motion vector prediction mechanisms, and so forth.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

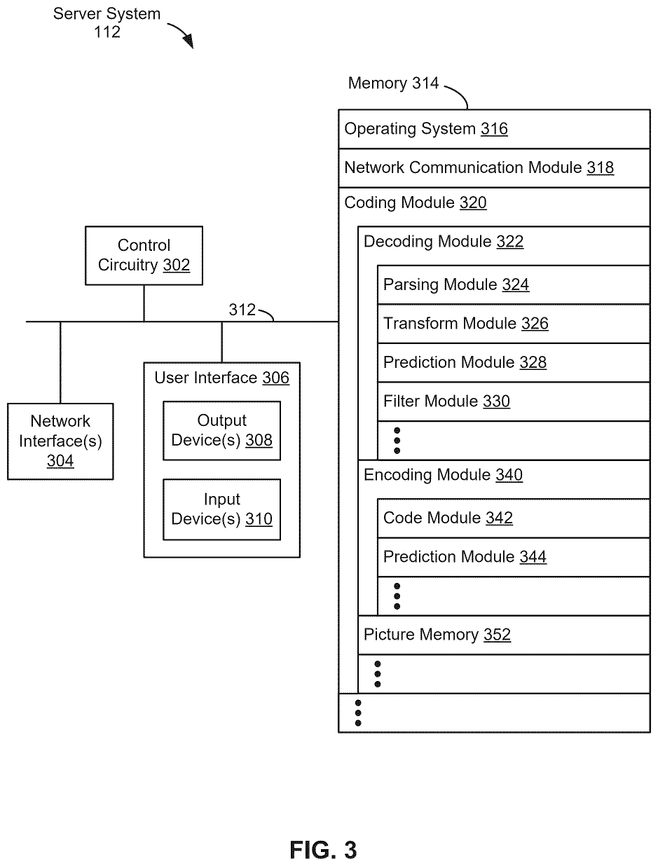

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes one or more field-programmable gate arrays (FPGAs), hardware accelerators, and/or one or more integrated circuits (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above, such as an audio processing module.

Although FIG. 3 illustrates the server system 112 in accordance with some embodiments, FIG. 3 is intended more as a functional description of the various features that may be present in one or more server systems rather than a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

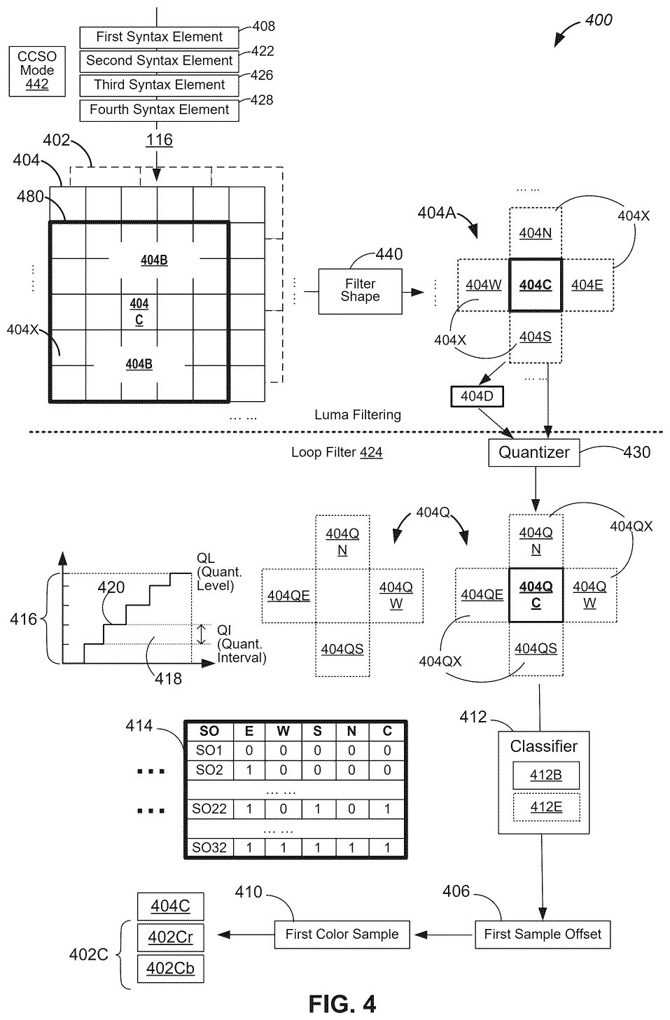

FIG. 4 is a flow diagram of an example process 400 of applying in-loop filtering based on a filter shape 440, in accordance with some embodiments. A GOP includes a sequence of image frames that further includes a current image frame. The current image frame includes a color image, i.e., a non-monochrome image frame, which has a plurality of color samples (e.g., chroma samples 402 and luma samples 404) co-located with one another. After the plurality of color samples of the current image frame are reconstructed, in-loop filtering is applied to adjust a subset of color samples, thereby improving an image quality of the current image frame. In some embodiments, a reconstructed sample and its neighboring reconstructed samples of a first color component are combined to derive an offset value for a second color component. A reconstructed sample of the second color component is co-located with the reconstructed sample of the first color component and adjusted by the offset value. The first color component is optionally identical to or distinct from the second color component. Particularly, in some embodiments, the neighboring reconstructed samples of the first color component are selected based on a filter shape 440 and combined for in-loop filtering to derive the offset value for the second color component (e.g., luma samples 404, chroma samples 402).

In some embodiments, a video bitstream 116 signals a current image frame, a first syntax element 408 for a CCSO mode 442. The first syntax element 408 indicates whether to generate a first sample offset 406 of a first color sample 410 of the current image frame based on one or more luma samples 404. In some embodiments, the first syntax element 408 has a first predefined value indicating that the CCSO mode 442 is enabled. In some embodiments, the first syntax element 408 is signaled in one of: a sequence header, a picture header, a slice header, a tile header, a tile group header, a superblock row header, a superblock header.

A decoder 122 receives the video bitstream 116 from an encoder 106. The video bitstream 116 includes a current image frame and a first syntax element 408 for a cross-component sample offset (CCSO) mode indicating whether to generate a first sample offset 406 of a first color sample 410 of the current image frame based on one or more luma samples 404. When the first syntax element 408 indicates that CCSO mode 442 is enabled, the decoder 122 identifies a plurality of candidate luma sets 404B in a filter range 480. The filter range 480 includes a first luma sample 404C collocated with the first color sample 410 and a plurality of neighboring luma samples 404X of the first luma sample 404C. Each candidate luma set 404B includes a plurality of respective luma samples 404X having positions that are symmetric with respect to a first position of the first luma sample 404C. Each luma sample 404 located in the filter range 480 is used in at least one of the plurality of candidate luma sets 404B. A set of target luma samples 404A is selected from the plurality of candidate luma sets 404B. For example, the set of target luma samples 404A include a first luma sample 404C collocated with the first color sample 410 and a plurality of respective luma samples 404X of the first luma sample 404C. The loop filter 424 is applied to combine the set of target luma samples 404A to generate the first sample offset 406 of the first color sample 410. The decoder 122 reconstructs the current image frame at least by adjusting the first color sample 410 based on the first sample offset 406.

In some embodiments associated with band offset classification, the CCSO mode 442 corresponds to a band offset classifier 412B. Based on the band offset classifier 412B, the decoder 122 determines that a set of target luma samples 404A includes a first luma sample 404C and one or more neighboring luma samples 404X. The set of target luma samples 404A are provided to a quantizer 430, and used to generate one or more quantized values 404Q, which are further applied by the band offset classifier 412B to classify the first color sample 410. For example, the filter shape 440 has a cross shape, and the set of neighboring luma samples 404A include the first luma sample 404C, a north luma sample 404N, a south luma sample 404S, a west luma sample 404W, and an east luma sample 404E. These luma samples 404 are further quantized to quantized values 404QC, 404QN, 404QS, 404QW, and 404QE, respectively.

Alternatively, in some embodiments associated with edge offset classification, the CCSO mode 442 corresponds to an edge offset classifier 412E. Based on the edge offset classifier 412E, the decoder 122 determines that a set of target luma samples 404A includes a first luma sample 404C and one or more neighboring luma samples 404X. Difference values of the neighboring luma samples 404X and the first luma sample 404C are provided to a quantizer 430, and used to generate one or more quantized values 404Q, which are further applied by the band offset classifier 412B to classify the first color sample 410. For example, the filter shape 440 has a cross shape, and four difference values 404D corresponding to the luma sample 404N, 404S, 404W, and 404E are further quantized to the quantized values 404QN, 404QS, 404QW, and 404QE, respectively.

The first color sample 410 is classified, e.g., by a classifier 412, based on the quantized values 404Q to determine the first sample offset 406 of the first color sample 410. In an example, the quantized values 404Q. A lookup table 414 maps a plurality of combinations of the quantized values 404Q to different sample offset options SO (e.g., SO1-SQ16). Based on the lookup table 414, the quantized values 404Q correspond to one of the combinations in the lookup table 414, and a corresponding sample offset option SO is identified to correspond to a combination of the quantized difference values 404Q and therefore selected for the first sample offset 406. In other words, in some embodiments, the decoder 122 classifies the first color sample 410 by identifying a combination of the one or more quantized values 404Q in a lookup table 414 associating a plurality of quantized combinations with a plurality of offset value options SO (e.g., SO-SO16) and determining the first sample offset 406 corresponding to the combination of the one or more quantized values 404Q in the lookup table 414.

In some embodiments, values of luma sample(s) 404A are quantized to a plurality of integer values in a quantization range 416 using a scalar quantizer 430 including a plurality of quantization intervals 418 (QI) and a plurality of quantization levels 420 (QL), and each of the one or more quantized values 404Q includes a respective integer in the quantization range 416. For each integer value in the quantization range 416, a quantization interval 418 is defined to be a range of values assigned to the respective integer value. A quantization level 420 corresponds to the respective integer value to which the range of difference values associated with the quantization interval 418 are assigned.

The first color sample 410 is adjusted based on the first sample offset 406 of the first color sample 410, thereby enabling reconstruction of the current image frame. In some embodiments, the first color sample 410 includes a first chroma sample 402C that is co-located with the first luma sample 404C in the current image frame, and the first chroma sample 402C is adjusted based on the first sample offset 406. Alternatively, in some embodiments, the first color sample 410 is the first luma sample 404C, and the first luma sample 404C is adjusted based on the first sample offset 406. Stated another way, in some embodiments, the first color sample 410 is one of: the first luma sample 404C, a first blue-difference chroma (Cb) sample 402Cr, and a first blue-difference chroma (Cb) sample 402Cb. The first luma sample 404C, the first Cb sample 402Cb, and the first Cr sample 402Cr are collocated with one another.

In some embodiments, the set of target luma samples 404A applied by the loop filter 424 is selected from the plurality of candidate luma sets 404B. The plurality of neighboring luma samples 404X includes a subset of first neighboring luma samples (e.g. 404N and 404E) and a subset of second neighboring luma samples (e.g., 404W and 404S). Each first neighboring luma sample is uniquely associated with a respective second neighboring luma sample. For each first neighboring luma sample, a respective position of the first neighboring luma sample and a respective position of the respective second neighboring luma sample are symmetric with each other with respect to a position of the first neighboring luma sample. Stated another way, in some embodiments, neighboring luma samples 404X are selected from the candidate luma sets 404B in pairs, and candidate luma set 404B includes a plurality of respective luma samples having positions that are symmetric positions with respect to the first luma sample 404C. In some situations, only one pair of neighboring luma sample 404X are selected to be combined with the first luma sample 404C in loop filtering. In some situations, two or more pairs of neighboring luma sample 404X are selected and applied by the loop filter 424.

In some embodiments, the decoder 122 stores, in a line buffer, luma samples of one or more upper lines located above the first luma sample 404C, one or more lower lines located below the first luma sample 404C, one or more left columns located to the left of the first luma sample 404C, or one or more right columns located to the right of the first luma sample 404C, and uses the luma samples stored in the line buffer to provide one or more candidate luma set 404B from which the set of target luma samples 404A applied by the loop filter 424 is selected.

In some embodiments, the filter range 480 has a first range shape (e.g. rectangular, diamond-shaped, rhombic, hexagonal, octagonal). A set of predefined range shapes are identified. The video bitstream 116 further includes a second syntax element 422 including a range shape index selecting one of the set of predefined range shapes as the first range shape, e.g., on one of a sequence, frame, or filtering unit level. Conversely, in some embodiments, no second syntax element 422 is transmitted in the video bitstream 116, and the first range shape is derived, e.g., based on a reference area.

In some embodiments, the set of target luma samples 404A are arranged according to a first filter shape 440 (e.g., a cross-shaped). A set of predefined filter shapes are identified. The video bitstream 116 further includes a third syntax element 426 including a filter shape index selecting one of the set of predefined filter shapes as the first filter shape 440, e.g., on one of a sequence, frame, or filtering unit level. Conversely, in some embodiments, no third syntax element 426 is transmitted in the video bitstream 116, and the first filter shape 440 is derived, e.g., based on a reference area.

In some embodiments, the filter range 480 has a first range shape, and the video bitstream 116 includes a second syntax element 422 including a range shape index and a third syntax element 426 including a filter shape index. A set of predefined range shapes is identified, and the first range shape is selected from the set of predefined range shapes based on the range shape index. A set of predefined filter shapes associated with the filter range 480 having the first range shape is identified. After the first range shape is selected, a first filter shape 440 is selected from the set of predefined filter shapes based on the filter shape index. The set of target luma samples 404A includes the first luma sample 404C, and are arranged according to the first filter shape 440.

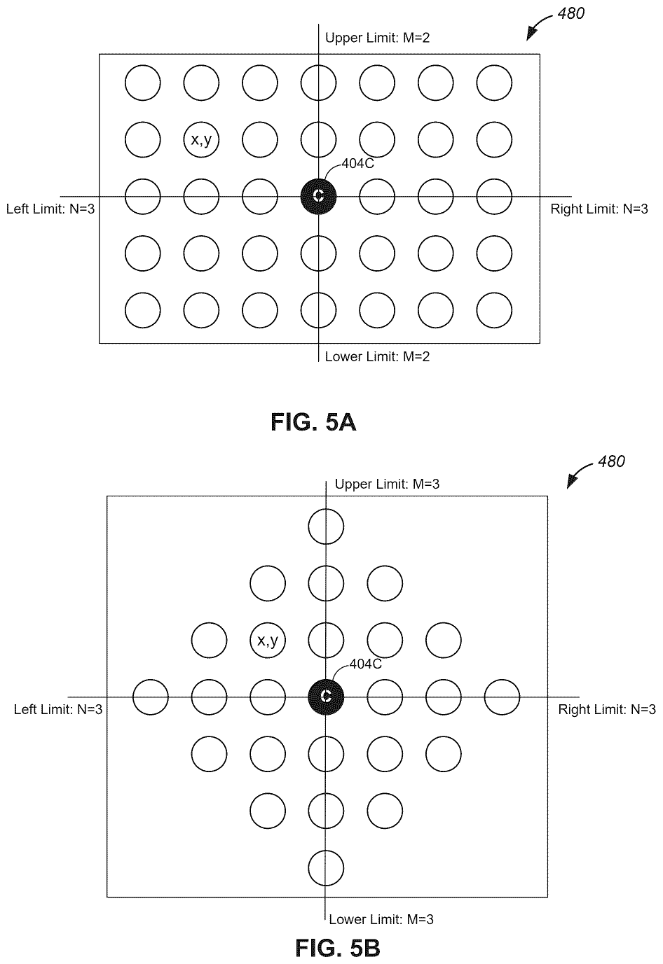

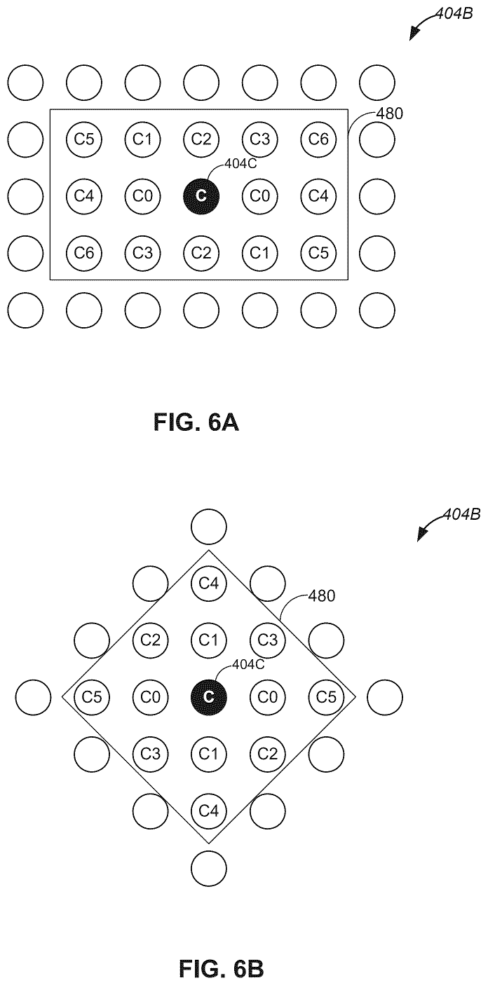

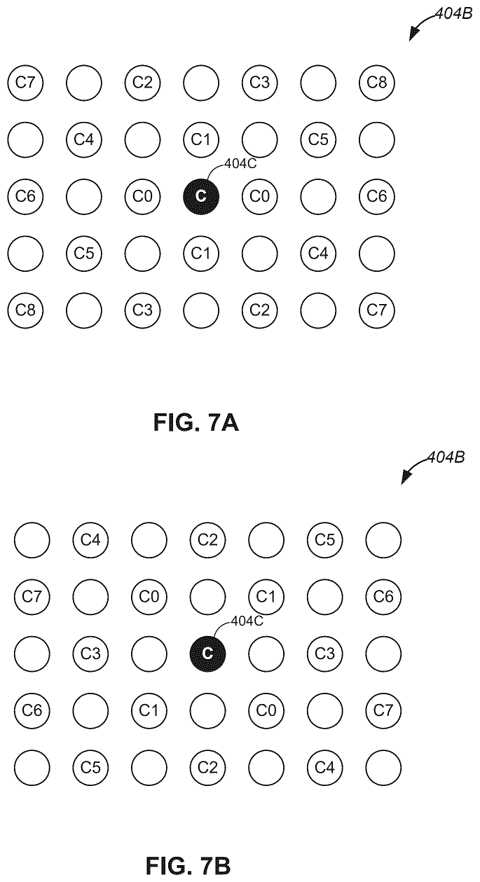

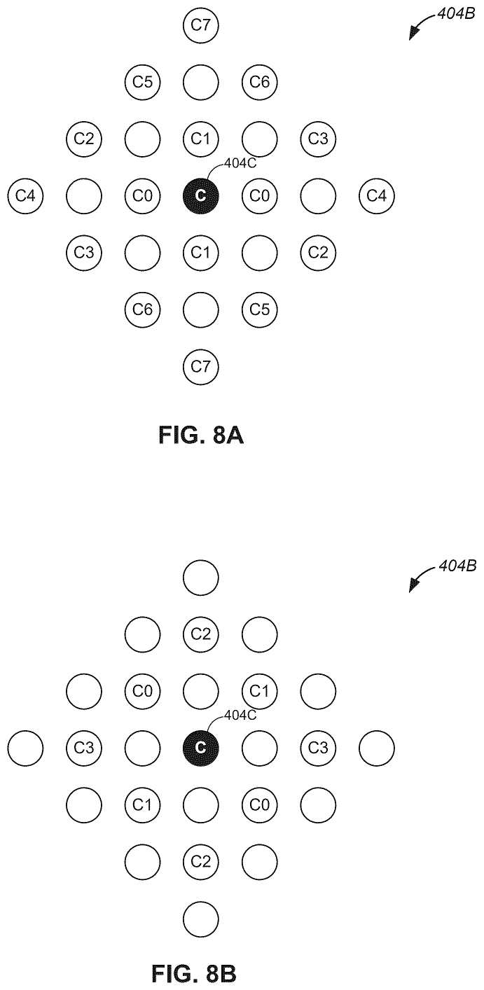

FIGS. 5A and 5B illustrate two example filter ranges 480 where a plurality of candidate luma sets 404B are identified, in accordance with some embodiments. The filter range 480 includes a first luma sample 404C collocated with the first color sample 410 and a plurality of neighboring luma samples 404X of the first luma sample 404C, and each candidate luma set 404B includes a plurality of respective luma samples (e.g., two neighboring luma samples 404X and the first luma sample 404C) having positions that are symmetric with respect to a first position of the first luma sample 404C. In some embodiments (FIGS. 6A and 6B), each luma sample 404 located in the filter range 480 is used in at least one of the plurality of candidate luma sets 404B. Alternatively, in some embodiments (FIGS. 7A, 7B, 8A, and 8B), each of a subset (e.g., less than all) of luma sample 404 located in the filter range 480 is used in at least one of the plurality of candidate luma sets 404B.

In some embodiments, the filter range 480 has a predefined dimension defined based on one or more range limits, and the one or more range limits include at least one of a horizontal neighboring sample number (N) and a vertical sample number (M). Further, in some embodiments, the filter range 480 is centered at the first luma sample 404C, and defined by: an M-th upper line located above the first luma sample 404C, an M-th lower line located below the first luma sample 404C, an N-th left column located to the left of the first luma sample 404C, and an N-th right column located to the right of the first luma sample 404C, inclusively. The set of target luma sample 404A is selected from a plurality of candidate luma sets 404B formed based on luma samples 404 in the filter range 480.

Referring to FIG. 5A, in some embodiments, a first range shape of the filter range 480 is rectangular. The integer number M is equal to 2, and the integer number N is equal to 3. The filter range 480 includes 5×7 luma samples centered at the first luma sample 404C. Each luma sample of the plurality of candidate luma sets 404B has a sample position (x, y) with respect to the first luma sample 404C, where x and y are integers, |x|≤N, and |y|≤M.

Referring to FIG. 5B, in some embodiments, a first range shape of the filter range 480 is diamond-shaped. The integer number M is equal to 3, and the integer number N is equal to 3. The filter range 480 includes 25 luma samples centered at the first luma sample 404C. Each luma sample of the plurality of candidate luma sets 404B has a sample position (x, y) with respect to the first luma sample 404C, where x and y are integers, |x|≤N, and |y|≤M and |x/N|+|y/M|≤1.

In some embodiments, the filter range 480 has a predefined dimension defined based on one or more range limits, and the one or more range limits include at least one of two horizontal neighboring sample number (N1 and N2) and a vertical sample number (M1 and M2). Further, in some embodiments, the filter range 480 is centered at the first luma sample 404C, and defined by: an M1-th upper line located above the first luma sample 404C, an M2-th lower line located below the first luma sample 404C, an N1-th left column located to the left of the first luma sample 404C, and an N2-th right column located to the right of the first luma sample 404C, inclusively.

FIGS. 6A and 6B illustrate a plurality of example candidate luma sets 404B identified in a filter range 480, in accordance with some embodiments. The filter range 480 includes a first luma sample 404C collocated with the first color sample 410 and a plurality of neighboring luma samples 404X of the first luma sample 404C, and each candidate luma set 404B includes a plurality of respective luma samples (e.g., two neighboring luma samples 404X and the first luma sample 404C) having positions that are symmetric with respect to a first position of the first luma sample 404C. In some embodiments, each luma sample 404 located in the filter range 480 is used in at least one of the plurality of candidate luma sets 404B. Stated another way, the filter range 480 includes a first number (F) of neighboring luma samples of the first luma sample 404C in total, and the plurality of candidate luma sets 404B includes a second number of candidate luma sets 404B. The second number (e.g., 7 or 6) equal to a half of the first number (e.g., 14 or 12).

Referring to FIG. 6A, in some embodiments, the filter range 480 has a rectangular range shape. The filter range 480 has a predefined dimension defined based on one or more range limits, and the one or more range limits include at least one of a horizontal neighboring sample number (N) and a vertical sample number (M). In this example, the horizontal neighboring sample number (N) is equal to 2, and the vertical sample number (M) is equal to 1. The filter range 480 includes 15 luma samples including the first luma sample 404C and 14 neighboring luma samples 404X. The filter range 480 includes 7 candidate luma sets 404B. Each candidate luma set 404B includes a pair of neighboring luma samples 404X having positions that are symmetric with respect to the first position of the first luma sample 404C. For example, the 7 candidate luma sets 404B includes luma sample pairs C0, C1, C2, C3, C4, C5, and C6.

Referring to FIG. 6B, in some embodiments, the filter range 480 has a diamond-shape range shape. The horizontal neighboring sample number (N) is equal to 2, and the vertical sample number (M) is equal to 2. The filter range 480 includes 13 luma samples including the first luma sample 404C and 12 neighboring luma samples 404X. The filter range 480 includes 5 candidate luma sets 404B. Each candidate luma set 404B includes a pair of neighboring luma samples 404X having positions that are symmetric with respect to the first position of the first luma sample 404C. For example, the 5 candidate luma sets 404B includes luma sample pairs C0, C1, C2, C3, C4, and C5.

FIGS. 7A and 7B illustrate a plurality of example candidate luma sets 404B identified in another filter range 480 having a rectangular shape, in accordance with some embodiments. The filter range 480 includes a first luma sample 404C collocated with the first color sample 410 and a plurality of neighboring luma samples 404X of the first luma sample 404C, and each candidate luma set 404B includes a plurality of respective luma samples (e.g., two neighboring luma samples 404X and the first luma sample 404C) having positions that are symmetric with respect to a first position of the first luma sample 404C. The filter range 480 has a predefined dimension defined based on one or more range limits, and the one or more range limits include at least one of a horizontal neighboring sample number (N) and a vertical sample number (M). The horizontal neighboring sample number (N) is equal to 3, and the vertical sample number (M) is equal to 2. The filter range 480 includes 35 luma samples including the first luma sample 404C and 34 neighboring luma samples 404X.

Referring to FIGS. 7A and 7B, in some embodiments, each of a subset (e.g., less than all) of luma sample 404 located in the filter range 480 is used in at least one of the plurality of candidate luma sets 404B. A subset of remaining luma samples is not used in any of the plurality of candidate luma sets 404B. In an example, each neighboring luma sample of the plurality of candidate luma sets 404B (e.g., candidate luma pairs C0, C1, . . . , and C8) has a sample position (x, y) with respect to the first luma sample 404C, where x and y are two integers, and a sum of the two integers is equal to an odd number. In another example, each neighboring luma sample of the plurality of candidate luma sets 404B (e.g., candidate luma pairs C0, C1, . . . , and C7) has a sample position (x, y) with respect to the first luma sample 404C, where x and y are two integers, and a sum of the two integers is equal to an even number.

FIGS. 8A and 8B illustrate a plurality of example candidate luma sets 404B identified in a filter range 480 having a diamond shape, in accordance with some embodiments. The filter range 480 includes a first luma sample 404C collocated with the first color sample 410 and a plurality of neighboring luma samples 404X of the first luma sample 404C, and each candidate luma set 404B includes a plurality of respective luma samples (e.g., two neighboring luma samples 404X and the first luma sample 404C) having positions that are symmetric with respect to a first position of the first luma sample 404C. The filter range 480 has a predefined dimension defined based on one or more range limits. Referring to FIG. 8A, in some embodiments, the horizontal neighboring sample number (N) and the vertical sample number (M) are equal to 3. Referring to FIG. 8B, in some embodiments, the horizontal neighboring sample number (N) and the vertical sample number (M) are equal to 2.

In some embodiments, each of a subset (e.g., less than all) of luma sample 404 located in the filter range 480 is used in at least one of the plurality of candidate luma sets 404B, while a subset of remaining luma samples is not used in any of the plurality of candidate luma sets 404B. In an example, each neighboring luma sample of the plurality of candidate luma sets 404B (e.g., candidate luma pairs C0, C1, . . . , and C7) has a sample position (x, y) with respect to the first luma sample 404C, where x and y are two integers, and a sum of the two integers is equal to an odd number. In another example, each neighboring luma sample of the plurality of candidate luma sets 404B (e.g., candidate luma pairs C0, C1, . . . , and C3) has a sample position (x, y) with respect to the first luma sample 404C, where x and y are two integers, and a sum of the two integers is equal to an even number.

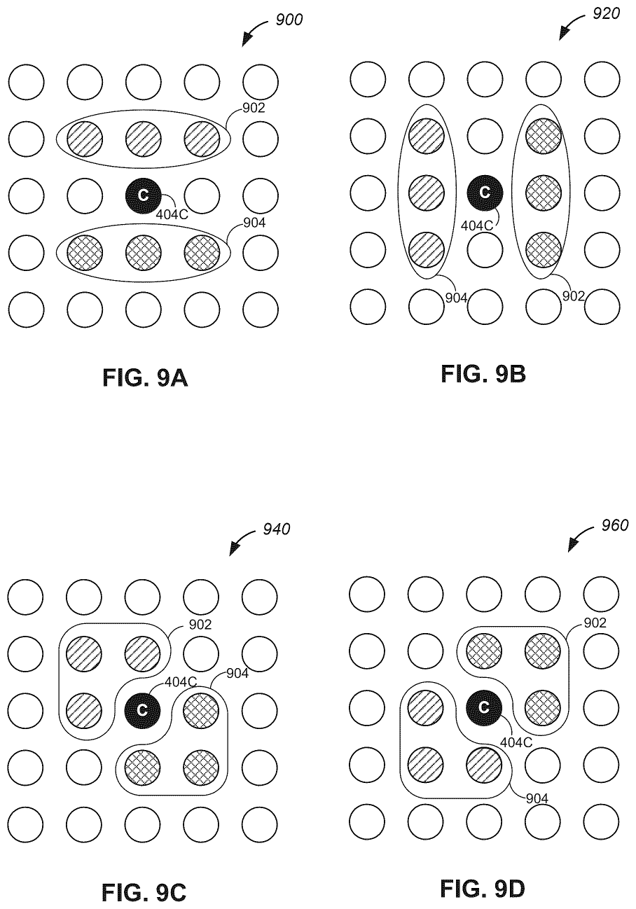

FIGS. 9A-9D are four example filter shapes 900, 920, 940, and 960 of combining more than two neighboring luma samples 404X in a CCSO mode, in accordance with some embodiments. A decoder 122 receives the video bitstream 116 from an encoder 106. The video bitstream 116 includes a current image frame and a first syntax element 408 for a cross-component sample offset (CCSO) mode indicating whether to generate a first sample offset 406 of a first color sample 410 of the current image frame based on one or more luma samples 404. When the first syntax element 408 indicates that CCSO mode 442 is enabled, the decoder 122 identifies a plurality of candidate luma sets 404B in a filter range 480. The filter range 480 includes a first luma sample 404C collocated with the first color sample 410 and a plurality of neighboring luma samples 404X of the first luma sample 404C. Each candidate luma set 404B includes a plurality of respective luma samples 404X having positions that are symmetric with respect to a first position of the first luma sample 404C. Each luma sample 404 located in the filter range 480 is used in at least one of the plurality of candidate luma sets 404B. A set of target luma samples 404A is selected from the plurality of candidate luma sets 404B. For example, the set of target luma samples 404A include a first luma sample 404C collocated with the first color sample 410 and a plurality of respective luma samples 404X of the first luma sample 404C. The loop filter 424 is applied to combine the set of target luma samples 404A to generate the first sample offset 406 of the first color sample 410. The decoder 122 reconstructs the current image frame at least by adjusting the first color sample 410 based on the first sample offset 406.

The set of target luma samples 404A include a first subset of target luma samples 902 and a second subset of target luma samples 904. When the loop filter is applied to combine the set of target luma samples 404A including the first luma sample 404C to generate the first sample offset 406 of the first color sample 410, the first subset of target luma samples 902 is combined to provide a first target luma value, and the second subset of target luma samples 904 is combined to provide a second target luma value. The first target luma value, the second target luma value, and the first luma sample 404C are combined to generate the first sample offset 406. Referring to FIG. 9A, in some embodiments, the first subset of target luma samples 902 includes a top left luma sample, a top luma sample, and a top right luma sample, and the second subset of target luma samples 904 includes a bottom left luma sample, a bottom luma sample, and a bottom right luma sample. Referring to FIG. 9B, in some embodiments, the first subset of target luma samples 902 includes a top left luma sample, a left luma sample, and a bottom left luma sample, and the second subset of target luma samples 904 includes a top right luma sample, a right sample, and a bottom right luma sample. Referring to FIG. 9C, in some embodiments, the first subset of target luma samples 902 includes a top left luma sample, a left luma sample, and a top luma sample, and the second subset of target luma samples 904 includes a right luma sample, a bottom sample, and a bottom right luma sample. Referring to FIG. 9D, in some embodiments, the first subset of target luma samples 902 includes a top right luma sample, a top luma sample, and a right luma sample, and the second subset of target luma samples 904 includes a bottom left luma sample, a left luma sample, and a bottom luma sample.

In some embodiments, a set of predefined filter fusion schemes is identified. The video bitstream 116 further includes a fourth syntax element 428 (FIG. 4) including a filter fusion flag selecting one of the set of predefined filter fusion schemes to identify the first subset of target luma samples 902 and the second subset of target luma samples 904 in the set of target luma samples 404A. Further, in some embodiments, the first subset of target luma samples 902, the second subset of target luma samples 904, and the first luma sample 404C are arranged according to a target filter shape 440. the video bitstream 116 includes a third syntax element 426 including a filter shape index selecting one of the set of predefined filter shapes as the target filter shape 440. The third syntax element 426 is signaled in the video bitstream 116 on a sequence, frame, slice, superblock, or coded block level. The video bitstream 116 further includes the fourth syntax element 428, which is signaled after the third syntax element 426. Additionally, in some embodiments, the third syntax element 426 is signaled on a frame level, and the fourth syntax element 428 is signaled on a coded block level.

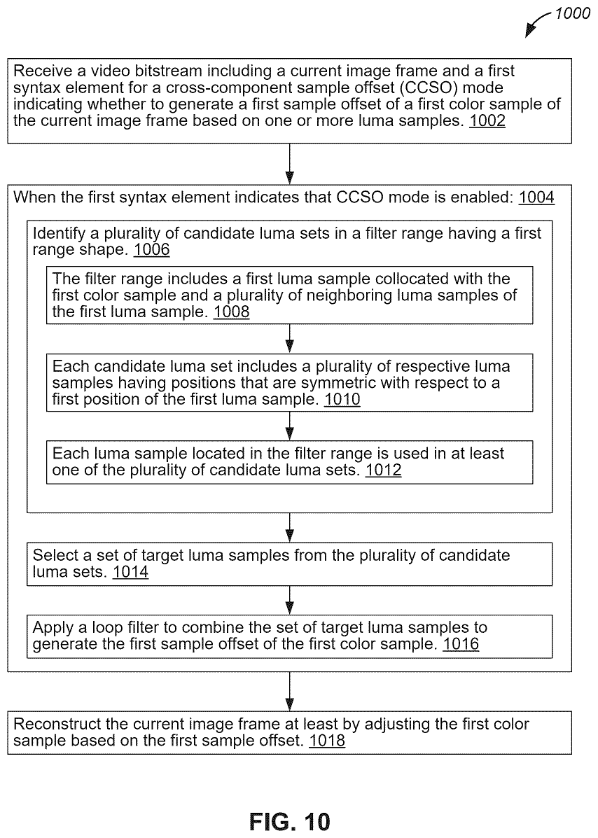

FIG. 10 is a flow diagram illustrating an example method 1000 of coding video, in accordance with some embodiments. The method 1000 may be performed at a computing system (e.g., the server system 112, the source device 102, or the electronic device 120 in FIG. 1) having control circuitry and memory storing instructions for execution by the control circuitry. In some embodiments, the method 1000 is applied jointly with one or more video codecs, including but not limited to, H.264, H.265/HEVC, H.266/VVC, AV1 and AVS/AVS2/AVS3. A cross-component offset filtering method is implemented based on an edge preserving loop filter that uses reconstructed samples (e.g., luma samples 404) to determine sample offsets 406 of luma samples 404 or chroma samples 402. The luma samples 404 may be classified based on band offsets (e.g., depending on luma samples 404) or edge offset (e.g., depending on gradient or difference values between a first luma sample 404C and neighboring luma samples 404X). Luma samples 404 located in positions defined by a filter shape are used to compute the sample offset 406 of a color sample (e.g., a first luma samples 404C or a first chroma sample 402C). It is proposed to have new filter shapes for cross component sample offset classification from the neighboring samples. One filter refers to a pair/set of symmetric or asymmetric samples used to calculate the classifier and offset. Filter shape refer to the shape of all available “filter(s)”within the filter range limit.

In some embodiments, the filter shape is defined by a specified range limit around the collocated reconstructed sample “C” (e.g., first luma sample 404C). The upper and lower range limits are denoted by M, while the left and right range limits are denoted by N. M and N can either be the same or different, and they are selected from the set {1, 2, 3, . . . , and L}, where L is a number smaller than a predefined limit. The shape of the filter range (e.g., a filter range 480 in FIG. 4) can be rectangular, diamond-shaped, or any other symmetric form. Any combination of the filter options within the filter range (e.g., a filter range 480) results in the filter shapes.

In an example, the filter range 480 is a rectangle with M=2 and N=3 (FIG. 5A). The allowed neighboring samples 404B are subject to specific constraints: for a rectangular filter, x≤N, and |y|≤M. In another example, the filter range 480 has a diamond shape with M=3 and N=3 (FIG. 5B). For diamond shape, the constraint is xN+|y/M|≤1, where x and y are integers.

In some embodiments, each filter option (e.g., a candidate luma set 404B) within the filter range 480 includes two neighboring samples 404X that are symmetric with respect to the center of the filter shape (e.g., the first luma sample 404C). Any combination of these filter options within the filter range 480 may be one option of a loop filter. If there are F neighboring samples 404X in the filter range 480, the combination can include any number of filter options less than or equal to F/2.

In some embodiments, for a rectangular filter range (e.g., range 480 in FIGS. 7A-7B), only a subset (e.g., less than all) of this range is used to provide a filter shape of a loop filter. In an example, each candidate luma set 404B includes a neighboring sample 404X with a position (x, y) in the rectangular range shape 480 (FIG. 7A). One of the horizontal index x and the vertical index y is even, and another index is odd. In another example, each candidate luma set 404B includes a neighboring sample 404X with a position (x, y) in the rectangular range shape 480 (FIG. 7B). The horizontal index (or coordinate) x and the vertical index y are both even or they are both odd.

In some embodiments, for a diamond-shaped filter range (e.g., range 480 in FIGS. 8A-8B), only a subset (e.g., less than all) of this range is used to provide a filter shape of a loop filter. In an example, each candidate luma set 404B includes a neighboring sample 404X with a position (x, y) in the rectangular filter range 480 (FIG. 8A). One of the horizontal index x and the vertical index y is even and another index is odd. In another example, f each candidate luma set 404B includes a neighboring sample 404X with a position (x, y) in the rectangular filter range 480 (FIG. 8B). The horizontal index x and the vertical index y are both even or they are both odd.

In some embodiments, a set of filter shapes may be pre-defined, and the index of the filter shape may be signaled (e.g., via the third syntax element 426) at sequence, frame, or filtering unit level.

In some embodiments, a set of filter ranges are pre-defined, and a set of filter shapes within the filter shape is predefined.

In some embodiments, the filter range shape and filter shape index are signaled at the sequence, frame, or filtering unit level, e.g., by the second syntax element 422 and the third syntax element 426, respectively.

In some embodiments, the filter range shape and the filter shape can be derived without signaling/parsing.

In some embodiments, the filter shape index is firstly signaled, e.g., by the second syntax element 422, and the filter index within the filter shape is signaled e.g., by the third syntax element 426, after the first shape index is signaled.

In some embodiments, multiple samples may be involved in one filter option to calculate the classifier and/or offset.

In some embodiments, referring to FIG. 9A, for a vertical direction, an average of the first subset of luma samples 902 is determined, and an average of the second subset of luma samples 904 is determined. The average of the first subset of luma samples 902, the average of the second subset of luma samples 904, and the first luma sample 404C are combined to in loop filtering to determine a first sample offset 406 of a first color sample 410.

In some embodiments, referring to FIG. 9C, for a diagonal direction, an average of the first subset of luma samples 902 is determined, and an average of the second subset of luma samples 904 is determined. The average of the first subset of luma samples 902, the average of the second subset of luma samples 904, and the first luma sample 404C are combined to in loop filtering to determine a first sample offset 406 of a first color sample 410.

In some embodiments, a flag, named as filter_fusion_flag, is signaled to indicate whether one pair or multiple pairs of samples (e.g., a set of target luma samples 404A) are used to calculate the classifier and/or offset in the cross component sample offset process. Further, in some embodiments, this flag is signaled after signaling the filter option index in sequence level, frame level, slice level, super block level, or coded block level. In some embodiments, the filter index and filter_fusion_flag is signaled in the different levels. In an example, the filter index is signaled in the frame level, but the filter_fusion_flag is signaled at the coded block level.

Although FIG. 10 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

Turning now to some example embodiments.
(A1) In some embodiments, a method 1000 for decoding video data includes: receiving (operation 1002) a video bitstream including a current image frame and a first syntax element for a cross-component sample offset (CCSO) mode indicating whether to generate a first sample offset of a first color sample of the current image frame based on one or more luma samples; when the first syntax element indicates that CCSO mode is enabled (operation 1004): identifying (operation 1006) a plurality of candidate luma sets in a filter range, wherein the filter range includes (operation 1008) a first luma sample collocated with the first color sample and a plurality of neighboring luma samples of the first luma sample, and each candidate luma set includes (operation 1010) a plurality of respective luma samples having positions that are symmetric with respect to a first position of the first luma sample, and wherein each luma sample located in the filter range is used (operation 1012) in at least one of the plurality of candidate luma sets; selecting (operation 1014) a set of target luma samples from the plurality of candidate luma sets; and applying (operation 1016) a loop filter to combine the set of target luma samples to generate the first sample offset of the first color sample; and reconstructing (operation 1018) the current image frame at least by adjusting the first color sample based on the first sample offset.
(A2) In some embodiments of A1, the filter range has a predefined dimension defined based on one or more range limits, and the one or more range limits include at least one of a horizontal neighboring sample number (N) and a vertical sample number (M).
(A3) In some embodiments of A1 or A2, a first range shape of the filter range is rectangular, and each luma sample of the plurality of candidate luma sets has a sample position (x, y) with respect to the first luma sample, where x and y are integers, |x|≤N, and |y|≤M.
(A4) In some embodiments, of A3 a first range shape of the filter range is diamond-shaped, and each luma sample of the plurality of candidate luma sets has a sample position (x, y) with respect to the first luma sample, where x and y are integers and |x/N|+|y/M|≤1.
(A5) In some embodiments of A1-A4, the filter range includes a first number (F) of neighboring luma samples of the first luma sample in total, and the plurality of candidate luma sets includes a second number of candidate luma sets, the second number equal to a half of the first number. (A6) In some embodiments of A1-A5, the filter range has a first range shape, the method further comprising: identifying a set of predefined range shapes, wherein the video bitstream further includes a second syntax element including a range shape index selecting one of the set of predefined range shapes as the first range shape on one of a sequence, frame, or filtering unit level.
(A7) In some embodiments of A1-A6, the set of target luma samples are arranged according to a first filter shape, the method further comprising: identifying a set of predefined filter shapes, wherein the video bitstream further includes a third syntax element including a filter shape index selecting one of the set of predefined filter shapes as the first filter shape on one of a sequence, frame, or filtering unit level.
(A8) In some embodiments of A1-A7, the filter range has a first range shape, and the set of target luma samples are arranged according to a first filter shape, the method further comprising: deriving the first range shape, wherein the first range shape is not signaled in the video bitstream. (A9) In some embodiments of A1-A8, the set of target luma samples and the first luma sample are arranged according to a first filter shape, and the first filter shape is not signaled in the video bitstream, the method further comprising: deriving the first filer shape.
(A10) In some embodiments of A1-A9, the filter range has a first range shape, and the video bitstream includes a second syntax element including a range shape index and a third syntax element including a filter shape index, the method further comprising: identifying a set of predefined range shapes; selecting the first range shape from the set of predefined range shapes based on the range shape index; identifying a set of predefined filter shapes associated with the filter range having the first range shape; and selecting a first filter shape from the set of predefined filter shapes based on the filter shape index, wherein the set of target luma samples and the first luma sample are arranged according to the first filter shape.
(A11) In some embodiments of A1-A10, for each candidate luma set, the plurality of respective luma samples include more than two respective luma samples.
(A12) In some embodiments of A1-A11, the set of target luma samples includes a first subset of target luma samples and a second subset of target luma samples, and applying the loop filter to combine the set of target luma samples including the first luma sample to generate the first sample offset of the first color sample further comprising: combining the first subset of target luma samples to provide a first target luma value; combining the second subset of target luma samples to provide a second target luma value; combining the first target luma value, the second target luma value, and the first luma sample to generate the first sample offset.

(A13) In some embodiments of A12, the first subset of target luma samples includes a top left luma sample, a top luma sample, and a top right luma sample, and the second subset of target luma samples includes a bottom left luma sample, a bottom luma sample, and a bottom right luma sample.
(A14) In some embodiments of A12 or A13, the first subset of target luma samples includes a top left luma sample, a left luma sample, and a bottom left luma sample, and the second subset of target luma samples includes a top right luma sample, a right sample, and a bottom right luma sample.
(A15) In some embodiments of any of A12-A14, the first subset of target luma samples includes a top left luma sample, a left luma sample, and a top luma sample, and the second subset of target luma samples includes a right luma sample, a bottom sample, and a bottom right luma sample.
(A16) In some embodiments of any of A12-A15, the first subset of target luma samples includes a top right luma sample, a top luma sample, and a right luma sample, and the second subset of target luma samples includes a bottom left luma sample, a left luma sample, and a bottom luma sample.
(A17) In some embodiments of any of A12-A16, the method further includes: identifying a set of predefined filter fusion schemes, wherein the video bitstream further includes a fourth syntax element including a filter fusion flag selecting one of the set of predefined filter fusion schemes to identify the first subset of target luma samples and the second subset of target luma samples in the set of target luma samples.
(A18) In some embodiments of A17, the first subset of target luma samples, the second subset of target luma samples, and the first luma sample are arranged according to a target filter shape, the method further comprising: identifying, in the video bitstream, a third syntax element including a filter shape index selecting one of the set of predefined filter shapes as the target filter shape, wherein the third syntax element is signaled in the video bitstream on a sequence, frame, slice, superblock, or coded block level; and identifying, in the video bitstream, the fourth syntax element, wherein the fourth syntax element is signaled after the third syntax element.
(A19) In some embodiments of A18, the third syntax element is signaled on a frame level, and the fourth syntax element is signaled on a coded block level.
(A20) In some embodiments of any of A12-A19, each candidate luma set includes two respective luma samples. (A21) A method for decoding video data includes: receiving a video bitstream including a current image frame and a first syntax element for a cross-component sample offset (CCSO) mode indicating whether to generate a first sample offset of a first color sample of the current image frame based on one or more luma samples; when the first syntax element indicates that CCSO mode is enabled: identifying a plurality of candidate luma sets in a filter range, wherein the filter range includes a first luma sample collocated with the first color sample and a plurality of neighboring luma samples of the first luma sample, and each candidate luma set includes a plurality of respective luma samples having positions that are symmetric with respect to a first position of the first luma sample; selecting a set of target luma samples from the plurality of candidate luma sets; and applying a loop filter to combine the set of target luma samples to generate the first sample offset of the first color sample; and reconstructing the current image frame at least by adjusting the first color sample based on the first sample offset; wherein each neighboring luma sample of the plurality of candidate luma sets has a sample position (x, y) with respect to the first luma sample, where x and y are two integers, and a sum of the two integers is equal to an odd number.
(A22) A method for decoding video data includes: receiving a video bitstream including a current image frame and a first syntax element for a cross-component sample offset (CCSO) mode indicating whether to generate a first sample offset of a first color sample of the current image frame based on one or more luma samples; when the first syntax element indicates that CCSO mode is enabled: identifying a plurality of candidate luma sets in a filter range, wherein the filter range includes a first luma sample collocated with the first color sample and a plurality of neighboring luma samples of the first luma sample, and each candidate luma set includes a plurality of respective luma samples having positions that are symmetric with respect to a first position of the first luma sample; selecting a set of target luma samples from the plurality of candidate luma sets; and applying a loop filter to combine the set of target luma samples to generate the first sample offset of the first color sample; and reconstructing the current image frame at least by adjusting the first color sample based on the first sample offset; wherein each neighboring luma sample of the plurality of candidate luma sets has a sample position (x, y) with respect to the first luma sample, where x and y are two integers, and a sum of the two integers is equal to an even number.
(A23) In some embodiments, a method of video encoding is implemented. The method includes receiving video data comprising a current image frame; encoding the current image frame; transmitting the encoded current image frame via a video bitstream; and signaling, via the video bitstream, a first syntax element for a cross-component sample offset (CCSO) mode indicating whether to generate a first sample offset of a first color sample of the current image frame based on one or more luma samples; wherein when the CCSO mode is enabled, a set of target luma samples is selected from a plurality of candidate luma sets in a filter range, and combined with a first luma sample, which is collocated with the first color sample, according to a loop filter to generate the first sample offset of the first color sample; wherein the filter range includes the first luma sample and a plurality of neighboring luma samples of the first luma sample, and each candidate luma set includes a plurality of respective luma samples having positions that are symmetric with respect to a first position of the first luma sample; and wherein each luma sample located in the filter range is used in at least one of the plurality of candidate luma sets.
(A24) In some embodiments, a method of bitstream conversion is implemented. The method includes obtaining a source video sequence including a current image frame; and performing a conversion between the source video sequence and a video bitstream, wherein the video bitstream comprises: the current image frame; and a first syntax element for a cross-component sample offset (CCSO) mode indicating whether to generate a first sample offset of a first color sample of the current image frame based on one or more luma samples; wherein when the CCSO mode is enabled, a set of target luma samples is selected from a plurality of candidate luma sets in a filter range, and combined with a first luma sample, which is collocated with the first color sample, according to a loop filter to generate the first sample offset of the first color sample; wherein the filter range includes the first luma sample and a plurality of neighboring luma samples of the first luma sample, and each candidate luma set includes a plurality of respective luma samples having positions that are symmetric with respect to a first position of the first luma sample; and wherein each luma sample located in the filter range is used in at least one of the plurality of candidate luma sets.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A24 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A24 above).

The proposed methods may be used separately or combined in any order. Further, each of the methods (or embodiments), encoder, and decoder may be implemented by processing circuitry (e.g., one or more processors or one or more integrated circuits). For example, the one or more processors execute a program that is stored in a non-transitory computer-readable medium. In the following, the term block may be interpreted as a prediction block, a coding block, or a coding unit, i.e., CU.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method for decoding video data, comprising:
receiving a video bitstream including a current image frame and a first syntax element for a cross-component sample offset (CCSO) mode indicating whether to generate a first sample offset of a first color sample of the current image frame based on one or more luma samples;
when the first syntax element indicates that the CCSO mode is enabled:
identifying a plurality of candidate luma sets in a filter range, wherein the filter range includes a first luma sample collocated with the first color sample and a plurality of neighboring luma samples of the first luma sample, and each candidate luma set includes a plurality of respective luma samples having positions that are symmetric with respect to a first position of the first luma sample, and wherein each luma sample located in the filter range is used in at least one of the plurality of candidate luma sets;
selecting a set of target luma samples from the plurality of candidate luma sets; and
applying a loop filter to combine the set of target luma samples to generate the first sample offset of the first color sample; and
reconstructing the current image frame at least by adjusting the first color sample based on the first sample offset.

2. The method of claim 1, wherein the filter range has a predefined dimension defined based on one or more range limits, and the one or more range limits include at least one of a horizontal neighboring sample number (N) and a vertical sample number (M).

3. The method of claim 2, wherein a first range shape of the filter range is rectangular, and each luma sample of the plurality of candidate luma sets has a sample position (x, y) with respect to the first luma sample, where x and y are integers, |x|≤N, and |y|≤M.

4. The method of claim 2, wherein a first range shape of the filter range is diamond-shaped, and each luma sample of the plurality of candidate luma sets has a sample position (x, y) with respect to the first luma sample, where x and y are integers and |x/N|+|y/M|≤1.

5. The method of claim 1, wherein the filter range includes a first number (F) of neighboring luma samples of the first luma sample in total, and the plurality of candidate luma sets includes a second number of candidate luma sets, the second number equal to a half of the first number.

6. The method of claim 1, wherein the filter range has a first range shape, the method further comprising:
identifying a set of predefined range shapes, wherein the video bitstream further includes a second syntax element including a range shape index selecting one of the set of predefined range shapes as the first range shape on one of a sequence, frame, or filtering unit level.

7. The method of claim 1, wherein the set of target luma samples are arranged according to a first filter shape, the method further comprising:
identifying a set of predefined filter shapes, wherein the video bitstream further includes a third syntax element including a filter shape index selecting one of the set of predefined filter shapes as the first filter shape on one of a sequence, frame, or filtering unit level.

8. The method of claim 1, wherein the filter range has a first range shape, and the set of target luma samples are arranged according to a first filter shape, the method further comprising:
deriving the first range shape {based on a reference area of the current coding block}, wherein the first range shape is not signaled in the video bitstream.

9. The method of claim 1, wherein the set of target luma samples and the first luma sample are arranged according to a first filter shape, and the first filter shape is not signaled in the video bitstream, the method further comprising:
deriving the first filer shape {based on a reference area of the current coding block}.

10. The method of claim 1, wherein the filter range has a first range shape, and the video bitstream includes a second syntax element including a range shape index and a third syntax element including a filter shape index, the method further comprising:
identifying a set of predefined range shapes;
selecting the first range shape from the set of predefined range shapes based on the range shape index;
identifying a set of predefined filter shapes associated with the filter range having the first range shape; and
selecting a first filter shape from the set of predefined filter shapes based on the filter shape index, wherein the set of target luma samples and the first luma sample are arranged according to the first filter shape.

11. The method of claim 1, wherein for each candidate luma set, the plurality of respective luma samples include more than two respective luma samples.

12. The method of claim 1, wherein the set of target luma samples includes a first subset of target luma samples and a second subset of target luma samples, and applying the loop filter to combine the set of target luma samples including the first luma sample to generate the first sample offset of the first color sample further comprising:
combining the first subset of target luma samples to provide a first target luma value;
combining the second subset of target luma samples to provide a second target luma value;
combining the first target luma value, the second target luma value, and the first luma sample to generate the first sample offset.

13. The method of claim 12, wherein the first subset of target luma samples includes a top left luma sample, a top luma sample, and a top right luma sample, and the second subset of target luma samples includes a bottom left luma sample, a bottom luma sample, and a bottom right luma sample.

14. The method of claim 12, wherein the first subset of target luma samples includes a top left luma sample, a left luma sample, and a bottom left luma sample, and the second subset of target luma samples includes a top right luma sample, a right sample, and a bottom right luma sample.

15. The method of claim 12, wherein the first subset of target luma samples includes a top left luma sample, a left luma sample, and a top luma sample, and the second subset of target luma samples includes a right luma sample, a bottom sample, and a bottom right luma sample.

16. The method of claim 12, wherein the first subset of target luma samples includes a top right luma sample, a top luma sample, and a right luma sample, and the second subset of target luma samples includes a bottom left luma sample, a left luma sample, and a bottom luma sample.

17. The method of claim 12, the method further comprising:
identifying a set of predefined filter fusion schemes, wherein the video bitstream further includes a fourth syntax element including a filter fusion flag selecting one of the set of predefined filter fusion schemes to identify the first subset of target luma samples and the second subset of target luma samples in the set of target luma samples.

18. The method of claim 17, wherein the first subset of target luma samples, the second subset of target luma samples, and the first luma sample are arranged according to a target filter shape, the method further comprising:
identifying, in the video bitstream, a third syntax element including a filter shape index selecting one of the set of predefined filter shapes as the target filter shape, wherein the third syntax element is signaled in the video bitstream on a sequence, frame, slice, superblock, or coded block level; and
identifying, in the video bitstream, the fourth syntax element, wherein the fourth syntax element is signaled after the third syntax element.

19. A computing system, comprising:
control circuitry; and
memory storing one or more programs configured to be executed by the control circuitry, the one or more programs further comprising instructions for:
receiving video data comprising a current image frame;
encoding the current image frame;
transmitting the encoded current image frame via a video bitstream; and
signaling, via the video bitstream, a first syntax element for a cross-component sample offset (CCSO) mode indicating whether to generate a first sample offset of a first color sample of the current image frame based on one or more luma samples;
wherein when the CCSO mode is enabled, a set of target luma samples is selected from a plurality of candidate luma sets in a filter range, and combined with a first luma sample, which is collocated with the first color sample, according to a loop filter to generate the first sample offset of the first color sample;
wherein the filter range includes the first luma sample and a plurality of neighboring luma samples of the first luma sample, and each candidate luma set includes a plurality of respective luma samples having positions that are symmetric with respect to a first position of the first luma sample; and
wherein each luma sample located in the filter range is used in at least one of the plurality of candidate luma sets.

20. A non-transitory computer-readable storage medium storing one or more programs for execution by control circuitry of a computing system, the one or more programs comprising instructions for:
obtaining a source video sequence including a current image frame; and
performing a conversion between the source video sequence and a video bitstream, wherein the video bitstream comprises:
the current image frame; and
a first syntax element for a cross-component sample offset (CCSO) mode indicating whether to generate a first sample offset of a first color sample of the current image frame based on one or more luma samples;
wherein when the CCSO mode is enabled, a set of target luma samples is selected from a plurality of candidate luma sets in a filter range, and combined with a first luma sample, which is collocated with the first color sample, according to a loop filter to generate the first sample offset of the first color sample;
wherein the filter range includes the first luma sample and a plurality of neighboring luma samples of the first luma sample, and each candidate luma set includes a plurality of respective luma samples having positions that are symmetric with respect to a first position of the first luma sample; and
wherein each luma sample located in the filter range is used in at least one of the plurality of candidate luma sets.
